(19) United States
(12) Patent Application Publication
(10) Pub. No.: US 2023/0182360 A1
(43) Pub. Date: Jun. 15, 2023

(54) DRIVE UNIT

(71) Applicant: ENGEL AUSTRIA GmbH, Schwertberg (AT)

(72) Inventor: Friedrich PERNKOPF, Gramastetten (AT)

(21) Appl. No.: 18/080,376

(22) Filed: Dec. 13, 2022

(30) Foreign Application Priority Data
Dec. 15, 2021 (AT) A 51001/2021

(51) Int. Cl. B29C 45/66

(52) U.S. Cl. CPC B29C 45/661

(57) ABSTRACT

A drive unit for driving at least one component of a molding machine, includes a first support, a spindle, a drive for rotating the spindle, a second support, a nut, at least one rod arranged on the second support, and an oil-tight seal. The spindle, the second support, and the nut are arranged along the spindle inside the oil-tight space in each movement position of the second support and the nut.

### BACKGROUND OF THE INVENTION

The invention relates to a drive unit for a molding machine and a molding machine with such a drive unit.

Drive units in the form of ball screws have long been used to drive components of molding machines. Roughly, two different embodiments of ball screws can be distinguished, namely:
those with a nut arranged non-rotatably and a spindle arranged rotatably, so that the nut moves along the spindle during rotation of the spindle, and
those with a spindle arranged non-rotatably and a nut arranged rotatably, so that the spindle moves through the nut during rotation of the nut.

The invention is concerned with the first embodiment of a ball screw.

### SUMMARY OF THE INVENTION

The object of the invention is to provide a drive unit and a molding machine in which there are higher dynamics and a higher loadability of the drive unit.

In a drive unit according to the invention, there are at least provided:
a first support,
a spindle with one end mounted rotatably in or on the first support and protruding from the first support,
a drive for rotating the spindle,
a second support,
a nut (which together with the spindle forms a ball screw) arranged non-rotatably in or on the second support and movable together with the second support along the spindle by rotating the spindle,
at least one rod which is arranged in or on the second support and is connectable to the at least one component to be driven of the molding machine or is formable as part of the at least one component, and
an oil-tight seal which is arranged on that side of the first support from which the spindle protrudes, so that together with the first support an oil-tight space results and the spindle, the second support and the nut are arranged along the spindle inside the oil-tight space in each movement position of the second support and the nut.

A drive unit according to the invention is characterized by a low inertia due to the rotatably arranged spindle. This results in higher dynamics at the same drive power. The oil-tight seal allows a sufficient lubrication of the ball screw, without having to accept soiling of the surrounding area.

The seal is preferably formed with unchangeable geometry, for example in the form of a cup-shaped cast part or a cylinder open on one side, and therefore designed, in terms of its dimensioning, for the maximum space requirements of the spindle, the nut and the second support. No formation as a thrust sleeve is therefore necessary.

A retrofitting in a molding machine is possible through the completed formation of the drive unit.

The drive for the spindle can be effected via a gear unit, for example a gear drive with a motor, which for example can be mounted on the first support.

The drive can be arranged outside the oil-tight space, preferably on that side of the first support which is opposite the side from which the spindle protrudes (dry design). This can advantageously be a toothed belt gear or a direct drive in the extension of the spindle.

Alternatively, the drive can be located in the oil-tight space and is preferably at least partly arranged in an oil pan of the oil-tight space (wet design).

Preferably, the first support is formed in the form of a plate and is preferably penetrated by the at least one rod.

The at least one rod can have a round cross section, penetrate the first support, and be sealed by an oil-tight rod seal.

The spindle can be sealed to the first support by an oil-tight radial shaft sealing ring or by an oil-tight cover.

Preferably, the second support is formed in the form of a yoke.

Preferably, an oil pan is arranged in the oil-tight space, in which the spindle is at least partly located. In addition to a sufficient lubrication of the ball screw, this also allows a cooling through the oil pan. Similarly, a gear train and/or the bearing of the spindle can also be cooled and lubricated in this way.

For the second support, in addition to the at least one rod, a linear guide is arranged inside the oil-tight room. This results in an improved support of the drive torque of the nut.

The gear unit driving the drive can be formed with parallel or any desired axles.

Preferably, in the case of a molding machine according to the invention, the first support is formed by an ejector support, an end plate, or a platen of the molding machine.

Preferably, in the case of a molding machine according to the invention, the at least one rod is connected to a crosshead of a toggle clamp mechanism of the molding machine.

Preferably, in the case of a molding machine according to the invention, the at least one rod is connected to a clamping cylinder of a mold clamping unit of the molding machine, in particular, via an ejector support.

Preferably, in the case of a molding machine according to the invention, the at least one rod is connected to a plasticizing drive of a plasticizing unit of the molding machine.

The molding machine according to the invention is preferably an injection-molding machine, particularly preferably a plastic injection-molding machine, or a transfer-molding machine.

### BRIEF DESCRIPTION OF THE DRAWINGS

Advantageous embodiments of the invention are discussed with reference to the Figures, in which:

FIG. 1 shows a drive unit according to the invention in isolation;

FIG. 2 shows a use of the drive unit according to FIG. 1 in a molding machine;

FIG. 3 shows a use of the drive unit according to FIG. 1 in a molding machine; and

FIG. 4 shows a use of the drive unit according to FIG. 1 in a molding machine.

### DETAILED DESCRIPTION OF THE INVENTION

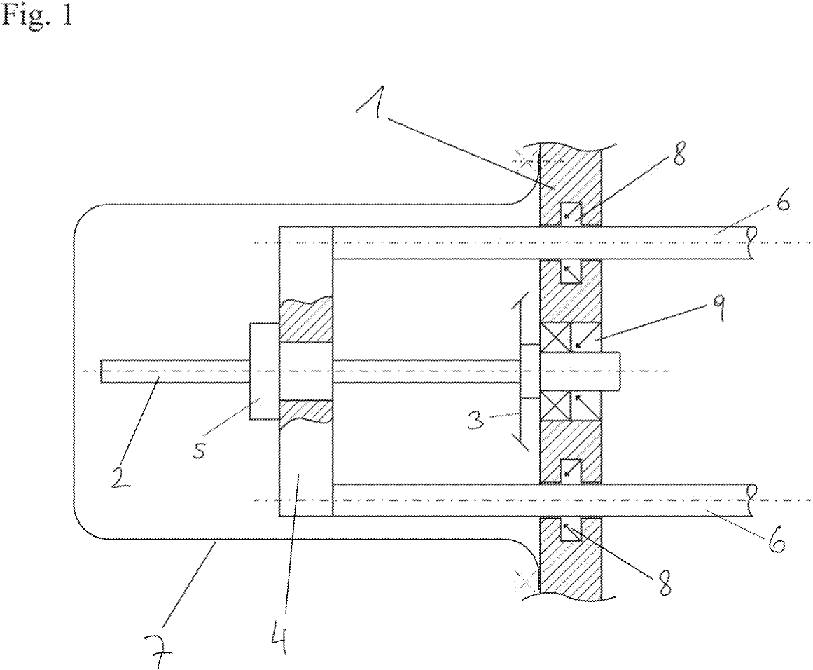

FIG. 1 schematically shows an embodiment of a drive unit according to the invention comprising:
a first support 1
a spindle 2 with one end mounted rotatably in or on the first support 1 and protruding from the first support 1
a drive 3 for rotating the spindle 2
a second support 4
a nut 5 arranged non-rotatably in or on the second support 4 and movable together with the second support 4 along the spindle 2 by rotating the spindle 2
at least one rod 6 which is arranged in or on the second support 4 and is connectable to the at least one component to be driven of the molding machine or formable as part of the at least one component
an oil-tight seal 7 which is arranged on that side of the first support 1 from which the spindle 2 protrudes, so that together with the first support 1 an oil-tight space results and the spindle 2, the second support 4 and the nut 5 are arranged along the spindle 2 inside the oil-tight space in each movement position of the second support 4 and the nut 5.

In the embodiment shown, the first support 1 is formed in the form of a plate. A spindle 2 is mounted immovably in the first support 1 via an oil-tight pivot bearing. A drive 3 for rotating the spindle 2 can be driven by a motor, not shown in FIG. 1, via a gear unit. The two rods 6 are sealed in relation to the first support 1 via rod seals 8. The bearing of the spindle 2 is sealed in relation to the first support 1 via a radial shaft sealing ring.

The second support 4 is formed in the form of a yoke, which is penetrated centrally by the spindle 2 and on which the nut 5 is non-rotatably arranged. Two rods 6 are mounted on the second support, which penetrate the first support and, in order to drive a component of a molding machine, can be connected to this or can be formed as part of such a component.

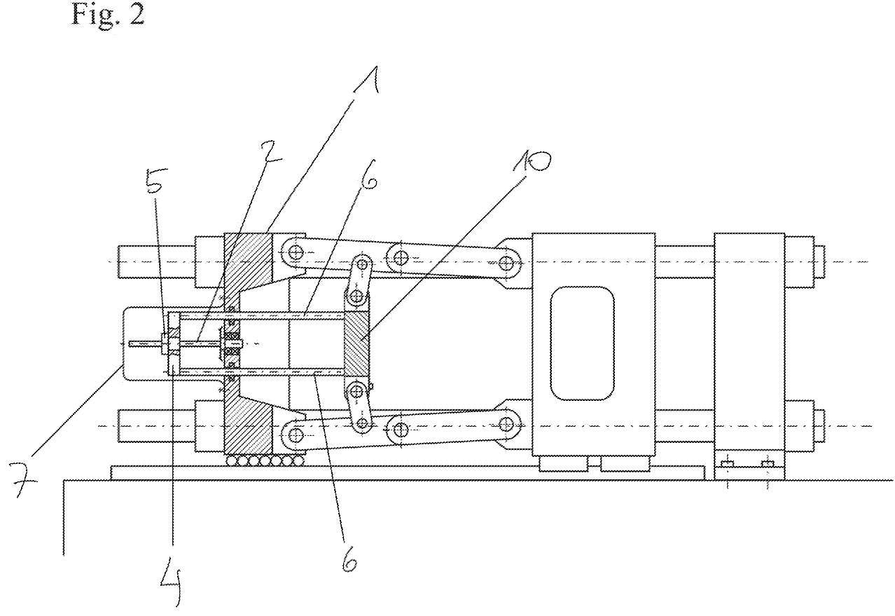

FIG. 2 shows a molding machine according to the invention in the form of a three-plate injection-molding machine, wherein two rods 6 are operatively connected to a crosshead 10 of a toggle clamp mechanism.

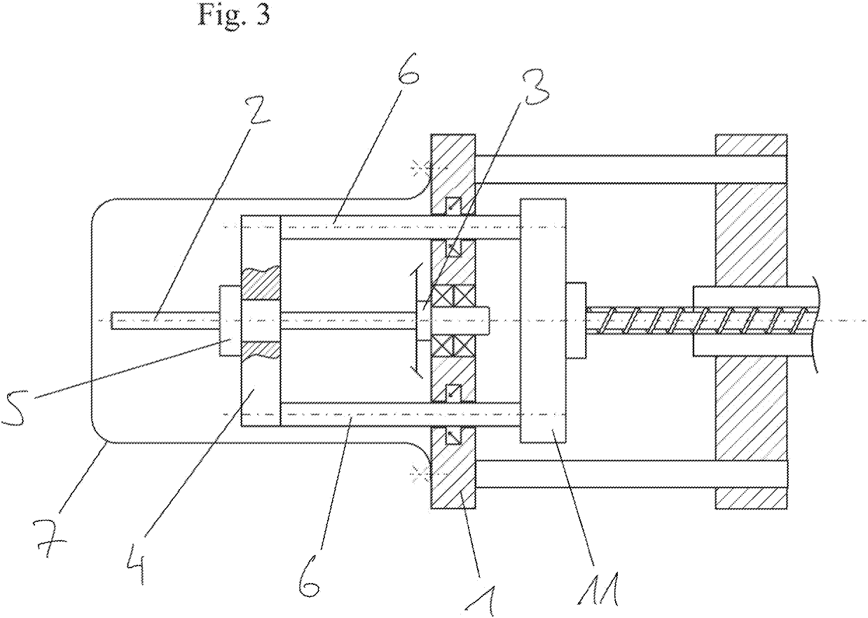

In FIG. 3 the drive unit according to the invention is used to drive a plasticizing drive 11 of an injection unit of a molding machine formed as an injection-molding machine.

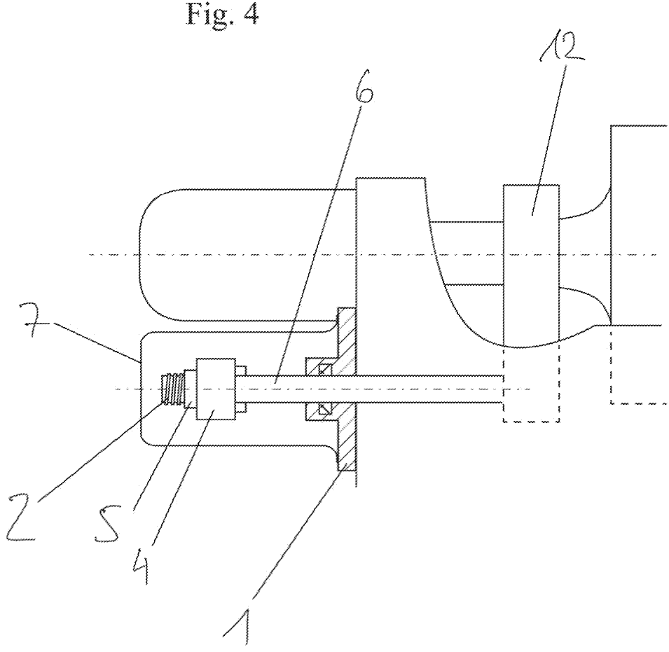

FIG. 4 shows a molding machine in the form of a tie-bar-less injection-molding machine, wherein the rods 6 are connected to an ejector support 12 and drive the mold clamping movement.

The possible uses of a drive unit according to the invention shown in FIGS. 2 to 4 are exemplary and to be understood in particular separately from the specific type of a molding machine shown in each case.

List of reference numbers:

| | |
|---|---|
| 1 | first support |
| 2 | spindle |
| 3 | drive |
| 4 | second support |
| 5 | nut |
| 6 | rod |
| 7 | seal |
| 8 | rod seal |
| 9 | radial shaft sealing ing |
| 10 | crosshead |
| 11 | plasticizing drive |
| 12 | ejector support |

1. A drive unit for driving at least one component of a molding machine, comprising:
a first support
a spindle with one end mounted rotatably in or on the first support and protruding from the first support on one side
a drive for rotating the spindle
a second support
a nut arranged non-rotatably in or on the second support and movable together with the second support along the spindle by rotating the spindle
at least one rod which is arranged on the second support and is connectable to the at least one component to be driven of the molding machine or formable as part of the at least one component
an oil-tight seal which is arranged on that side of the first support from which the spindle protrudes, so that together with the first support an oil-tight space results and the spindle, the second support and the nut are arranged along the spindle inside the oil-tight space in each movement position of the second support and the nut.

2. The drive unit according to claim 1, wherein the first support is formed in the form of a plate and is preferably penetrated by the at least one rod.

3. The drive unit according to claim 1, wherein the second support is formed in the form of a yoke.

4. The drive unit according to claim 1, wherein an oil pan is arranged in the oil-tight space, in which the spindle is at least partly located.

5. The drive unit according to claim 1, wherein the at least one rod has a round cross section, penetrates the first support and is sealed by an oil-tight rod seal.

6. The drive unit according to claim 1, wherein the spindle is sealed to the first support by an oil-tight radial shaft sealing ring or by an oil-tight cover.

7. The drive unit according to claim 1, wherein the drive is located in the oil-tight space and is preferably at least partly arranged in an oil pan of the oil-tight space.

8. The drive unit according to claim 1, wherein the drive is arranged outside the oil-tight space, preferably on that side of the first support which is opposite the side from which the spindle protrudes.

9. The drive unit according to claim 1, wherein, for the second support, in addition to the at least one rod, a linear guide is provided inside the oil-tight space.

10. A molding machine, in particular injection-molding machine or transfer-molding machine, with the drive unit according to claim 1.

11. The molding machine according to claim 10, wherein the first support is formed by an ejector support, an end plate or a platen of the molding machine.

12. The molding machine according to claim 10, wherein the at least one rod is connected to a crosshead of a toggle clamp mechanism of the molding machine.

13. The molding machine according to claim 10, wherein the at least one rod is connected to a rapid traverse cylinder of the molding machine.

14. The molding machine according to claim 10, wherein the at least one rod is connected to a plasticizing drive of a plasticizing unit of the molding machine.
